(19) United States
(12) Patent Application Publication
(10) Pub. No.: US 2010/0007115 A1
(43) Pub. Date: Jan. 14, 2010

(54) Motorcycle Grip Pad, System, Motorcycle and Riding Apparel therefor

(75) Inventor: Malcolm Wootton, Hope Valley (GB)

Correspondence Address: CRAIN, CATON & JAMES, FIVE HOUSTON CENTER, 1401 MCKINNEY, 17TH FLOOR, HOUSTON, TX, 77010, US

(73) Assignee: MOTO COMP LIMITED, Hope Valley (GB)

(21) Appl. No.: 12/376,212

(22) PCT Filed: Aug. 2, 2007
(86) PCT No.: PCT/GB2007/002915

§ 371 Date: Feb. 3, 2009

(30) Foreign Application Priority Data
Aug. 4, 2006 (GB) 0615520.4

(51) Int. Cl. B62J 25/00; A41D 3/02; A41D 1/06; A41D 19/00; A43B 5/00

(52) U.S. Cl. 280/304.4; 2/93; 2/227; 2/159; 36/131

(57) ABSTRACT

A motorcycle grip pad comprises a base layer of elastomeric material having spaced bumps on a top surface. An adhesive layer is on a bottom surface. The area of the pad is between 1000 and 4000 mm2. A motorcycle grip system also includes a reaction patch of relatively rigid material having apertures spaced and arranged in the same way as the bumps on the pad. The patch is adapted for connection to a motorcycle rider's suit (74,88) or other apparel. A wear pad for a motor cycle comprises a base sheet in the form of a flexible plastics sheet; an adhesive layer on the underside side of the flexible sheet; a release layer under the adhesive layer and protecting it during handling and storage; a top layer of soft, flexible elastomeric resin, which is poured onto the top surface prior to curing so that it spreads over the pad to its edges; and bumps of elastomeric material arranged on said base sheet prior to pouring of the polyurethane entrapping said bumps on said sheet, said bumps protruding above the level of said top layer.

This invention relates to a motorcycle grip pad and system, and a motorcycle and riding apparel adapted to employ the pad and system.

### BACKGROUND

Tyre technology is such that performance motorcycles can lean to extreme angles while cornering—up to 60 degrees with respect to the vertical. When leaning to such an extent, although also to much lesser degrees, it is always necessary for the rider to lean even further than the bike is canted over. Apart from getting the centre of gravity of the machine and rider lower, this also means that the bike leans less and therefore may have better grip on the road, allowing it to corner faster and/or more safely.

When cornering in this fashion, riders effectively “hang” from the bike, because their inside leg is also canted over, with the knee almost (or actually) scraping the ground. Thus their outside leg has to grip the far side (outside) of the bike to stop them falling off. (Obviously, the rider is also holding onto the motorcycle handle bars, as well.) The present invention is concerned with arrangements to assist riders to maintain contact with the bike during cornering. However, an aspect of the invention that must be borne in mind is that the riders need to change sides of the bike as they corner first in one direction and then in the other. In racing situations, chicanes require a fast transition between left and right cornering, but even on the normal road there will be times when a rider wants to change direction promptly. Thus the rider needs to be able to slide freely, when desired, from a right cornering position on the bike to a left cornering position, and vice versa.

There are also other situations in which the rider needs to grip the motorcycle in order to retain position, such as when braking heavily and there is a tendency to slide forward on the seat of the bike.

### BRIEF SUMMARY OF THE DISCLOSURE

In accordance with the broadest aspect of the present invention there is provided a motorcycle grip pad comprising a base layer of elastomeric material having spaced bumps on a top surface thereof and an adhesive layer on a bottom surface thereof, which adhesive layer is provided with a removable release layer protecting said adhesive during handling and which is suitable for adhesion at least to painted metal without damage to such paint. The area of the pad is preferably between 1000 and 5000 mm².

“Painted metal” here means the painted metal bodywork of motor vehicles as presently marketed by motor manufacturers in Europe and the USA. Such paint is necessarily relatively hard and resistant to mechanical abrasion.

In another aspect, the invention provides a motor cycle comprising bodywork including a seat disposed behind a fuel tank, a grip pad as defined above being adhered at least one on each side of the bodywork. In this case, the fuel tank comprises a part of the bodywork of the motor cycle.

Preferably the grip pad is adhered to the tank at a location adjacent a respective outside knee of the rider intending to ride the motorcycle when seated on the seat and adopting a cornering attitude with respect to the bike and for each direction of cornering.

Obviously, this aspect of the invention depends on the particular rider, who forms no part of the present invention, and it is not suggested that the grip pad of the invention would be adhered to the motorcycle fuel tank, or any other part of the bike, until the rider intending to ride the motorcycle had determined the best location for the pads, given his or her particular riding style.

Preferably, the grip pads are between 1200 and 3000 mm² in area, especially between 1300 and 1500 mm². Preferably, the centres of said bumps are spaced from one another by between 8 and 20 mm, and have a base diameter of between 4 and 8 mm. If the base of the bumps is not circular, said base diameter is the maximum dimension of said base. Preferably, said spacing is between 10 and 15 mm. Said base diameter may be between 5 and 7 mm. Preferably, the height of said bumps from said top surface is between 1 and 8 mm, and may be between 2 and 5 mm. Said bumps may be truncated cones having a base diameter as defined above connecting with said top surface, and a top size of between 2 and 5 mm, preferably between 3 and 4 mm. Preferably, the top of said truncated cone is provided with a dimple whereby the top of the bump is a circular ridge.

Preferably, said bumps are in an equilateral triangular formation. Preferably, said grip pad is hexagonal in shape so that multiple pads may be disposed in side by side relation without spaces between.

In a second aspect, the invention further provides a reaction patch of relatively rigid material having a thickness between 2 and 8 mm and apertures spaced and arranged in the same way as the bumps on the pad, and said patch is adapted for connection to an area of a motorcycle rider's suit. Preferably, said patch is adapted for connection by having a plurality of pin-holes spaced around its circumference whereby it can be sewn to the suit knee without a needle having to puncture the patch in the sewing process.

Preferably, the patch is a plastics material such as polypropylene or the like.

The reaction patch could be removably attached using hook and pile type fasteners, such as Velcro® (ie using mating hooked and hooped material). Knee-sliders on leather race suits are generally attached in this way, with a larger Velcro® patch sewn onto the suit so that the smaller knee-slider has a degree of freedom of location. A similar arrangement could be provided with the reaction patches.

Indeed, preferably, the reaction patch is incorporated into the suit design. The key location positions would evolve over time.

Thus the invention also provides motorcycle riding apparel comprising such reaction pads. Indeed, the invention provides motorcycle riding apparel with hoop or hook pile fastener areas adapted for attachment of reaction pads as defined above. In this case “adapted” means located in areas suitable and intended for connection of such reaction pads where a rider wearing such apparel may reasonably desire such reaction pads to be connected for the purpose described herein. Apparel here means: trousers and jacket (whether integrated as a single article or as separate components), boots and gloves. Areas suitable and potentially intended for connection of such reaction pads non-exclusively include: inside leg areas; inside arm areas; inside ankle and foot areas; and inside wrist areas. It is, of course, understood that it is unlikely that Velcro® type patches have not been employed on motorcycle riding apparel in the past for the purpose of securing elements of the apparel together, but this is not the same as being suitable and intended for connection of the reaction patches of the present invention.

In use, a rider, wearing a suit with said patches on the inside of the knee or elsewhere and said grip pads adhered to the fuel tank at the appropriate location (or elsewhere on the motorcycle bodywork), engages the patch with the pad and, during cornering or braking or other manoeuvres, a number of the bumps on the pad enter the apertures on the patch and assist the rider in gripping the machine, resisting relative sliding of the patch over the grip pad. During transition, the knee is released from lateral pressure (ie pressure substantially normal to the pad) and so can slide over the pad with minimal resistance as the rider adjusts his or her position on the cycle seat.

From the foregoing, it is immediately apparent that, without departing from the invention, two alternative arrangements are possible. In the first, the apertures are provided not on the patch, but on the pad, and bumps are provided on the patch. While feasible, this has the disadvantage that the relatively rigid material of the patch is formed into bumps that the rider will draw across the surface of the fuel tank as and when he or she makes adjustments to their position. This might lead to scratching of the paintwork. Furthermore, for normal walking, the patches on the insides of the knees of the motor cycle suit may rub and catch against one another in an undesirable way. This problem also occurs in the second alternative, when the pad has the apertures, as in the first alternative, but, here, is also the relatively rigid component, made from polypropylene or the like, and the patch, while having the bumps, is constructed from the softer elastomeric material. However, part of the benefit of having the pad made from a flexible elastomeric material is that it easily conforms to the contours of a fuel tank or other motorcycle surface, whereas a more rigid component may have edges that stand proud of the tank or other surface and be likely to be caught. Thus, while within the ambit of the present invention, the preferred form is as defined herein.

While the arrangement as described above is very satisfactory for racing purposes, it does not have a great deal of aesthetic appeal.

It is known to provide wear pads that are adhered to the top and/or side surfaces of fuel tanks (and other areas of the motorcycle that might be susceptible to damage) to stop scratching of the paint work on said parts by buttons and zips on the rider's clothing as he or she leans over the tank and moves across it during cornering. Such wear pads conveniently comprise: a base sheet in the form of a flexible sheet of PVC or similar plastics, on a top side of which decorative or informative indicia may be printed; an adhesive layer on the underside side of the flexible sheet; a silicone release layer under the adhesive layer and protecting it during handling and storage; a top, rather thick, layer of soft, transparent polyurethane or like elastomer, which is poured onto the top surface prior to curing so that it spreads over the pad to its edges. If the PVC layer is previously weeded out around the intended periphery of the wear pad, the polyurethane forms a shallow meniscus at the periphery, giving the pad a relatively sharp edge. That makes the wear pad more flexible at the edge, so that it can conform to the profile of the fuel tank in this critical region where good adhesion is necessary and again to avoid proud edges that can catch on clothing and the like. On the other hand, giving the polyurethane a good thickness renders the pad as a whole relatively rigid, so that getting it to stick flat without creasing or trapping bubbles, (which is easily done with very flexible adhesive sheets) against the tank surface is possible for inexperienced personnel. The polyurethane cures to a very smooth finish, and preferably also is transparent, so that the printing on the base sheet is visible.

Thus the present invention provides such a wear pad in which bumps of elastomeric material are provided on said base sheet prior to pouring of the polyurethane entrapping said bumps. Preferably, said bumps are interconnected by a network of links. Indeed, preferably, said bumps are part of a grip pad according to the first aspect of the invention in which said base is an open mesh. In this event, the adhesive layer of the grip pad may be omitted, relying on the elastomer poured onto the base sheet adhering and retaining the grip pad to the wear pad base sheet.

The dimensions of the grip pad in this application may be as preferred above, although in this event the height of the bumps may be reduced by the thickness of the elastomeric layer of the wear pad. Accordingly, it may be preferred to increase the height of the bumps in this embodiment by an amount equal to the thickness of the elastomeric layer so that the height of the bumps above the level of the wear pad is as defined above.

### BRIEF DESCRIPTION OF THE DRAWINGS

Embodiments of the invention are further described hereinafter, by way of example, with reference to the accompanying drawings, in which:

FIGS. 1a and b are respectively a side view and section on the line II-II in FIG. 1a of a detail of a mesh grip unit for use in a wear pad according to the invention;

FIGS. 2a to c are respectively a plan view of a single grip pad according to the present invention, a scrap section on the line b-b in FIG. 2a, and a plan view of a plurality of the pads of FIG. 2a side by side;

FIGS. 3a and b are respectively a view similar to FIG. 1a and a plan view in the direction of the arrow B in FIG. 3a;

FIG. 4 is a plan view of a mesh;

FIGS. 5a and b are sectional side views and Figures c and d show respectively a top down and perspective view of a sheet mesh for use in a wear pad according to the invention;

FIG. 6 is a side view of a motorcycle having a wear pad according to the present invention applied to its fuel tank;

FIGS. 7a and b are views of motor cycle riding apparel incorporating reaction patches, or areas for attachment thereof, FIG. 7a being trousers and boots, FIG. 7b, a glove, and FIG. 7c, part of a jacket;

FIGS. 8a and b are a plan view and side view, partly in section of two embodiments of a reaction patch according to the present invention;

FIGS. 9a and b are respectively a perspective view and a top down view of a receiving pad, FIG. 9c is a section on the line A-A in FIG. 9b, FIG. 9d is a section on the line E-E of FIG. 9b, FIG. 9e shows a detail H of FIG. 9d, FIG. 9f is a section on the line K-K of FIG. 9b and FIG. 9g shows a detail L of FIG. 9f;

FIG. 10a shows a group of three receiving pads as shown in FIGS. 9a and b, and FIG. 10b shows the group of receiving pads of FIG. 10a receiving an inverted pad;

FIGS. 11a to c are respectively a top down view, a perspective view and a side view of a receiving pad and an inverted pad partially engaged;

FIG. 12 shows a detailed view of a typical bump of the receiving or inverted pads;

FIG. 13 shows the different paths that the bumps of the inverted pad can take when it is partially engaged with the receiving pad;

FIGS. 14a and b give a perspective view and a top down view respectively of a receiving pad and inverted pad fully engaged, and FIGS. 14c and d give the view across section A-A of FIG. 14b and the detail B of FIG. 14c; and

FIGS. 15a and b give a perspective view and a top down view respectively of a receiving pad and inverted pad semi-engaged, and FIGS. 15c and d give the view across section A-A of FIG. 15b and the detail B of FIG. 15c.

### DETAILED DESCRIPTION

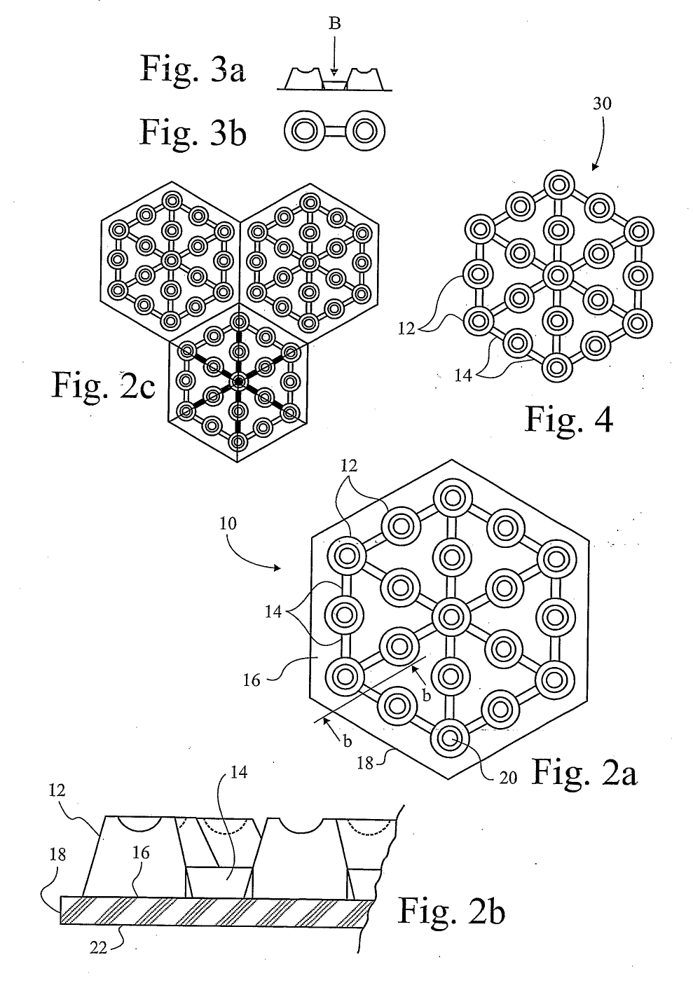

In FIG. 2a a grip pad 10 is a moulding of an elastomeric plastics material, such as polyurethane, having both a certain stiffness and at the same time some resilient flexibility. The degree of stiffness and flexibility is a matter of design choice. The flexibility is needed to allow the grip pad to follow the broad contours of a motorcycle fuel tank. Since it is anticipated that this will generally be to a relatively flat area of the fuel tank, the flexibility need not be substantial. The stiffness is there to resist bending and deflection when being gripped by a rider's knee. On the other hand, absolute rigidity is not desirable either, because some give would be desirable to mould better to the opposing surface gripping the pad, as described further below, as well as grip of the pad. The material is preferably transparent, but this is not essential to its function, although it may be desirable from an aesthetic perspective. The pad 10 has a series of bumps 12 on its surface, interconnected by webs or links 14, and upstanding from a top surface 16 of a base layer 18. The base layer 18 in the embodiment illustrated is hexagonal in plan and has a thickness between about about 1 and 3 mm.

The bumps 12 are frusto conical having approximate dimensions of: height of 5 mm; base diameter of 7 mm; and to top diameter of about 5 mm. A dimple 20 is formed in the top surface of 3 mm in diameter leaving a circular ridge of 1 mm thickness. This improves the grip of the pad 10. The bumps are preferably in an equilateral triangular formation with centre-to-centre separations of 12 mm. The pad is about 52 mm flat to flat in width, with sides of length about 30 mm. The webs 14 support the bumps, but in the present embodiment are not essential and can be omitted. An adhesive layer 22 is provided on the bottom of base layer 18. This may be a coating of adhesive, or applied by double-sided tape. In either event, for handling, packaging, and transportation, and sale, the adhesive layer is protected by a release layer (not shown). The adhesive is preferably a pressure-contact adhesive, suitable for application to vehicle bodywork or the like.

An advantage of the hexagonal arrangement is that multiple pads 10 can be placed side by side as shown in FIG. 2c to cover a larger area as may be desired without gaps between.

FIG. 4 shows a bump mesh 30. Here the base layer 18 is omitted for reasons discussed further below and in which the webs 14 link the bumps 12 together and keep them in formation.

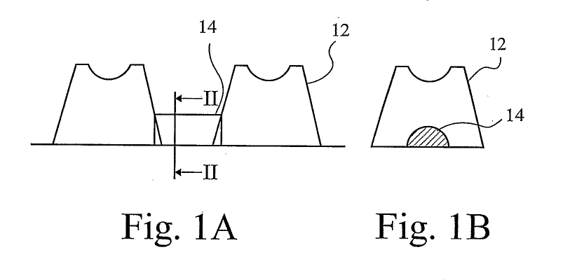

FIGS. 1a and b, and FIGS. 3a and b, show a detail of two bumps 12.

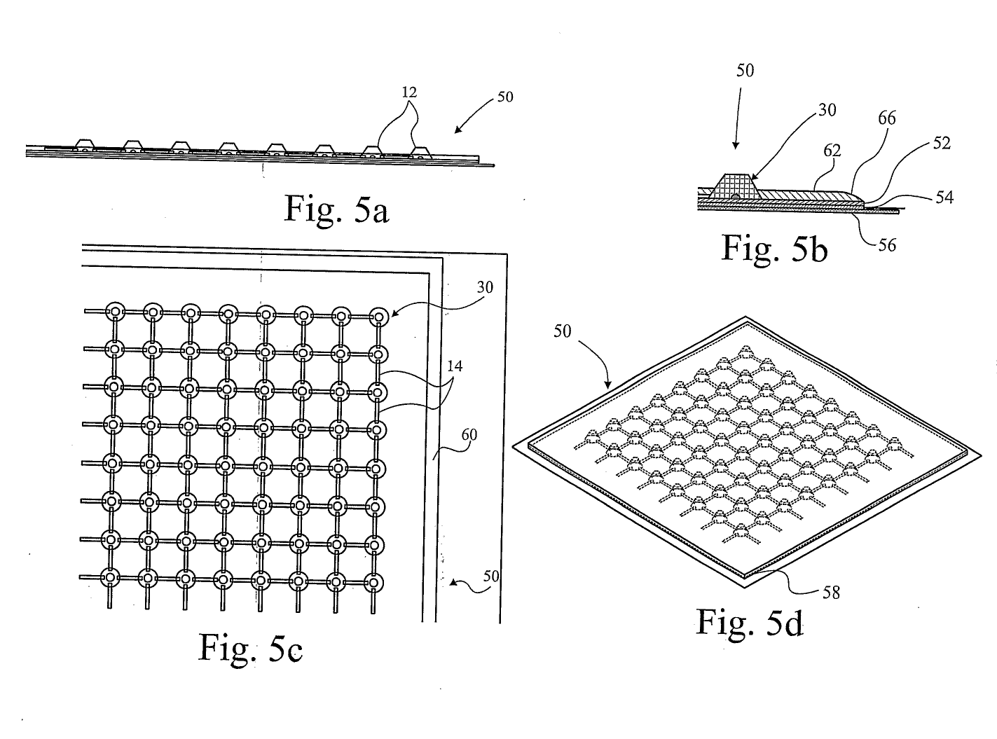

FIGS. 5a to d illustrate a construction of a wear pad 50 according to the present invention. Here, a bump mesh 30 is placed on the top surface of a PVC (poly vinyl chloride) base sheet 52, which has an adhesive layer 54 on its underside, as known in the art, protected by a silicone or similar release or backing layer 56 (see FIG. 5b for detail). Generally, the release layer extends beyond the edge 58 of the base sheet. Indeed, it may extend substantially beyond the edge of the wear pad 50 which may be shaped (other than rectangularly as shown in FIG. 5c). In this event, merely a gap 60 may exist between the PVC base layer of the wear pad, and scrap PVC beyond. The gap may be formed by a weeding process following cutting of PVC layer 52 into the desired wear pad shape.

The mesh 30 may be adhered to the base sheet 52 by an adhesive layer it has, or it may simply be positioned as desired. In any event, liquid polyurethane resin is poured onto the base sheet 52 covering its entire surface and enveloping the mesh 30 including the webs 14, but not covering the bumps 12. Indeed, the depth of the top layer 62 so-formed is about 2.5 mm, leaving a similar height or more of the bumps 12 protruding through.

The elastomeric resin poured onto the base must be compatible with both the resin of the bump mesh 30 and the base sheet 52 so that it adheres strongly to both. Polyurethane is suitable, although different grades may be selected so that the bumps might be stiffer, for example, than the softer top layer 62, or indeed, vice versa. It is a feature of such wear pads that, at the edge of the wear pad a smooth meniscus 66 forms, providing the wear pad with a relatively sharp edge that conforms more easily to the contours of the tank on which it is to be adhered. Indeed, there is a certain flexibility in the wear pad so formed that it can conform to the surface of the tank. Nevertheless, such wear pads are frequently provided with a skeletal outline so that more pronounced surface contours can be accommodated without leaving edges or sections standing proud.

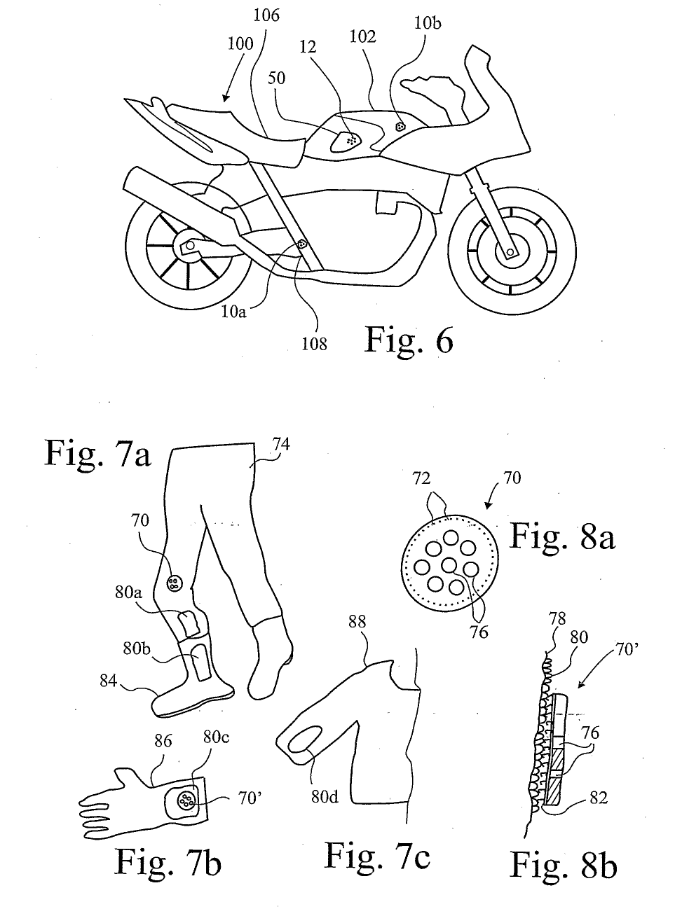

FIG. 6 shows a motor cycle 100 having a wear pad 50 according to the present invention on one side of the fuel tank 102. Another (not visible) would be on the other side. Bumps 12 are here located in just a single region of the wear pad, coinciding with the location where the knee of a rider (not shown) sitting on the seat 106 of the bike 100 would be positioned. The pad 50 is shaped to suit the pattern and shape of the tank 102 and may be printed on its PVC base layer 52 with appropriate decorative or informative indicia (provided the top layer 62 is transparent).

A grip pad 10a is also shown connected to an element 108 of the bike bodywork, being in this case a frame tube which happens to be located in the region of the ankle of a rider using the bike 100. Likewise, another grip pad 10b could be connected to the forward part of the tank 102 to possibly provide additional grip for the wrist or inner arm of the rider. Of course, if the tank 102 or frame 108 are not located where the rider needs a grip pad, then the grip pad could be connected to other components of the bike, which in this event, and for the purposes of this document, are considered parts of the bike bodywork, even if it is a gearbox housing, for example. Furthermore, elements could be connected to the bike to enable fixation of a grip pad if the appropriate location is not suitable for connection of a grip pad (for example a hot exhaust pipe, or even simply a space in the position where it is necessary for a pad to be located).

On their own, the bumps 12 of a wear pad 50 as described above, or a grip pad 10, 10a or 10b, as described above, provide enhanced friction locations to enable a rider to grip the side of the bike during cornering or braking better than when they are not present.

However, a further aspect of the invention provides a reaction patch 70, shown in FIGS. 8a and b. This comprises a sheet of semi-rigid plastics material such as polypropylene or the like. Pinholes 72 are disposed around the periphery so that it can be sewn to the inside of the knee-region of motorcycle-suit trousers 74. Again, one is provided on each knee (for example) and each has holes or apertures 76 in an array corresponding with the arrangement of bumps 12 on the grip pad 10 or wear pad 50. The arrangement is such that the bumps slip easily into the holes 76 when the rider presses his or her knee towards the bike fuel tank. The bumps grip the pad more effectively, being not just a friction grip, but also a mechanical interference grip. However, just by releasing the sideways pressure, the knee should relatively easily slip over the pad 10,50 when the cornering on that side is finished and the rider is transitioning to an upright stance, or to the opposite direction.

Indeed, although the bumps 12 are shown as symmetrical, there is no absolute requirement for this, and indeed, some asymmetry may be desirable so that the grip pad grips better in one direction than in another. For example, one application of the grip pad may be Lo assist in maintaining body position while braking. Both thighs might grip the fuel tank in this circumstance and the bumps may have orthogonal sides in the direction of forward motion when in their working position. However, their other side may be inclined so as to slide out more easily when braking has finished.

FIG. 8b shows, partly in section, and alternative attachment adaptation for a reaction patch 70′. Here, the rider's apparel 78 is provided with an area 80 of hooped nylon or like fabric. To the rear surface of the patch 70′ is adhered a hooked nylon or like material layer 82, whereby the patch 70′ may be connected to any desired area of the apparel 78.

In FIGS. 7a,b and c, such apparel may comprise trousers 74, which here is shown with a patch 70 sewn in place. However, the inside leg is shown with an area 80a of hooped material. A boot 84 has a hooped area 80b at the ankle. In FIG. 7b, a glove 86 has an area 80c to which a patch 70′ is shown connected. In FIG. 77c, a jacket 88 has an area 80d on the inside arm part of the jacket. Any of the hooped areas 80a-d are suitable for and intended for attachment of patches 70′. Of course, the patches could have hooped fabric and the apparel be provided with hooked material in the areas 80a-d, if desired.

The pad 10 and the bump mesh 30 are conveniently made in the same mould (not shown) into which curable resin is poured. Indeed, it may be an open cast mould where the webs 14 are formed by runners in the mould linking the pots that form each bump. Then, it is only a case of increasing the fill depth by 2 or 3 mm to form also the base layer 18 of the pad 10. However, it is equally possible that individual injection moulds may be employed.

In use, the present invention may be used:
to assist the rider in handling the loads on him when braking—in which case he or she may grip both sides of the bike simultaneously;
when cornering (as described above); and
to allow for other contact areas, e.g. ankle(boot)-to-frame/bike structure; chest-to-bodywork(tank); arm-to-bodywork; and possibly even glove to handle bar, etc.

A further benefit in use would be when riding over rough ground; it is often beneficial to ride either standing-up, or at least taking most of the weight through the rider's feet. In this case it may be advantageous to be able to reliably grip the inner sides of the legs (thighs, knees, calves, ankles) against the sides of the bike, whatever component one was touching on the bike.

Further benefits of the invention are:
contact grip will hardly reduce when wet, compared with the grip between wet leather and paintwork;
level of grip is much less dependent on the force applied by the rider;
bike will be easier to ride when the rider is either fatigued and/or injured;
cosmetically, the grip pad will protect the bodywork from wear and tear (abrasion, etc) caused by the rider sliding and gripping with whatever he or she grips with.

An alternative version of the grip pad could have non-symmetrical studs/bumps, (e.g a shallower-angled face or rib/ramp on one side) so that they grip more in one direction than another when engaging with the mating part (or vice versa), to make it easier to disengage when sliding from side to side, or when making the transition from braking to hanging-off for cornering.

When using a grip pad alone, the ‘bumps’ would probably be fairly soft, so that they grip the rider's suit better. When used with a mating part (reaction pad) they could be stiffer, so enhancing the mechanical grip when engaged in the mating holes. In this event, the bumps would deform less, so possibly perform more reliably.

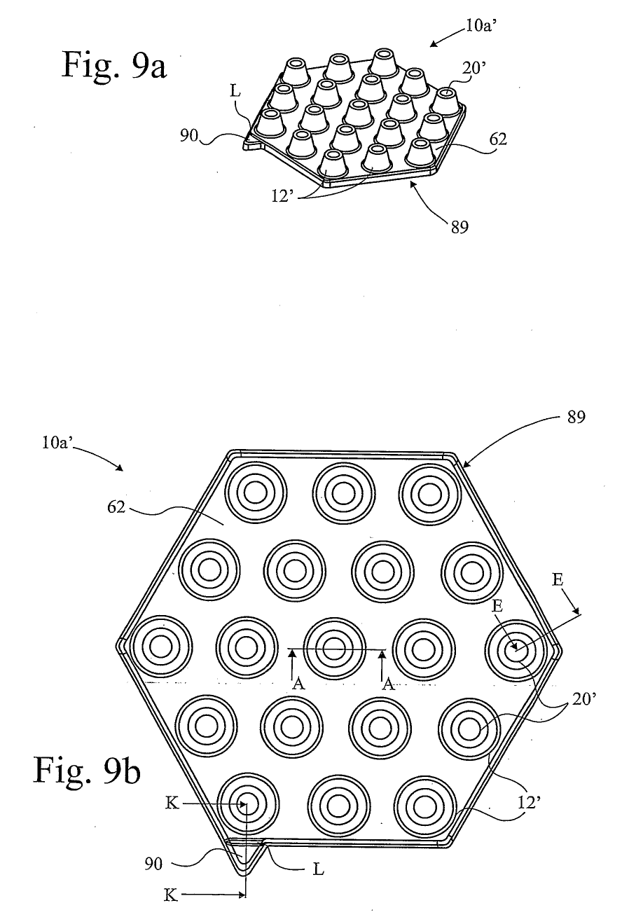

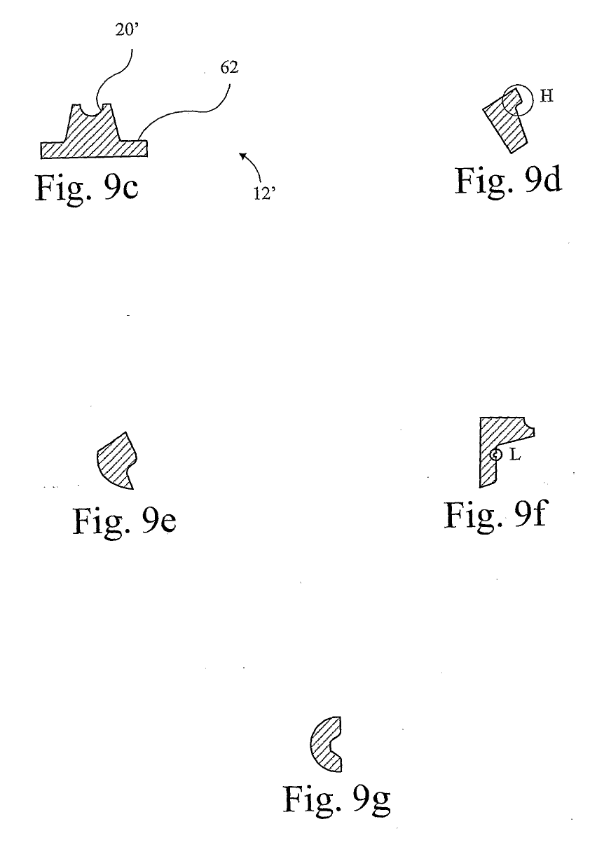

Another embodiment of the invention makes use of identical pads comprising bumps whereby the bumps of one pad interlock into the spaces between the bumps on the receiving pad. FIGS. 9a and b show one such pad 10a′ to be hexagonal with sides approximately 30 mm, and comprise an array of frusto conical bumps 12′ on an equilateral triangular lattice of about 12 mm. In this embodiment, the bumps 12′ have the approximate dimensions of: height of 5 mm; base diameter of 7.5 mm; and a top diameter of about 5 mm. A dimple 20′ of diameter 3 mm is formed in the top surface leaving a circular ridge of 1 mm thickness, improving the grip of the pad 10a′. The bumps 12′ may be connected by webs 14 (not shown in FIGS. 9 to 15, but being as described above for the embodiment shown in FIG. 4), although this is not an essential requirement. Where the bumps 12′ are connected by webs 14, the top layer 62 of the pad 10a′ is formed by pouring liquid polyurethane resin onto a base sheet 52 enveloping the webs 14, but leaving bumps 12′ of the dimensions given above protruding. The pad 10a′ has a thickness of approximately 2 mm from the base of the bumps 12′. FIGS. 9d and e show that the intersection of the bumps and the top layer 62 of the pad 10a′ is curved with a radius of 0.5 mm. Furthermore, the edges of the pad 10a′ are curved with a radius of 0.5 mm also.

The pad 10a′ comprises a triangular tab 90 positioned at one of the vertices of the hexagonal part or base 89, such that two sides of the triangular tab 90 are continuations of the edges of the hexagonal part 89. The triangular tab 90 also has curved edges and vertices in the same manner as the edges and vertices of the hexagonal part 89 of the pad 10a′. A shallow notch L with an approximate depth of 0.3 mm runs along the edge of the hexagonal part 89 of the pad 10a′ where it joins the triangular tab 90 allowing the triangular tab 90 to be removed easily if it is not required. The notch L is shown in greater detail in FIGS. 9f and g.

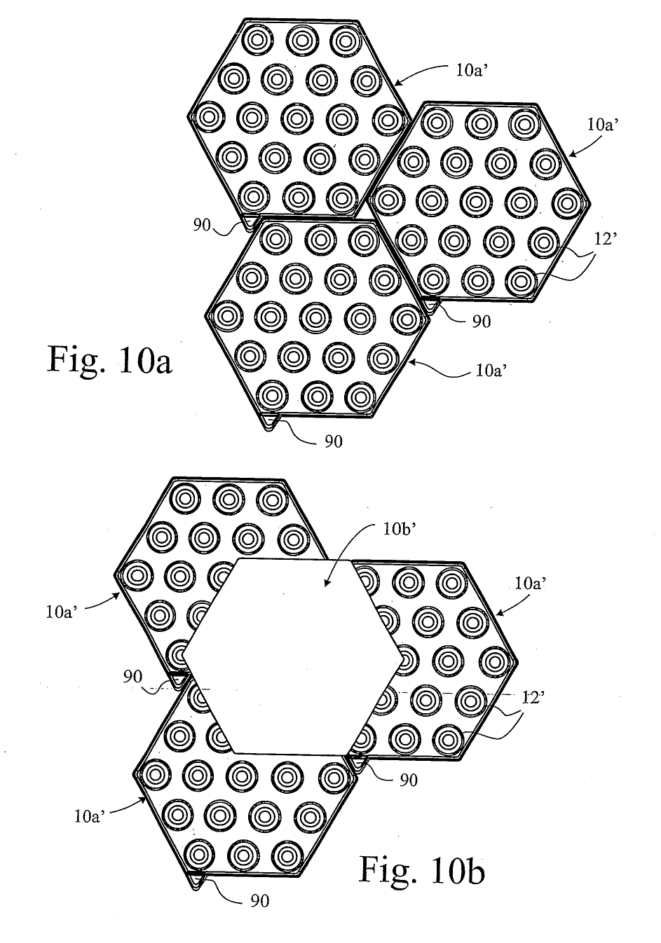

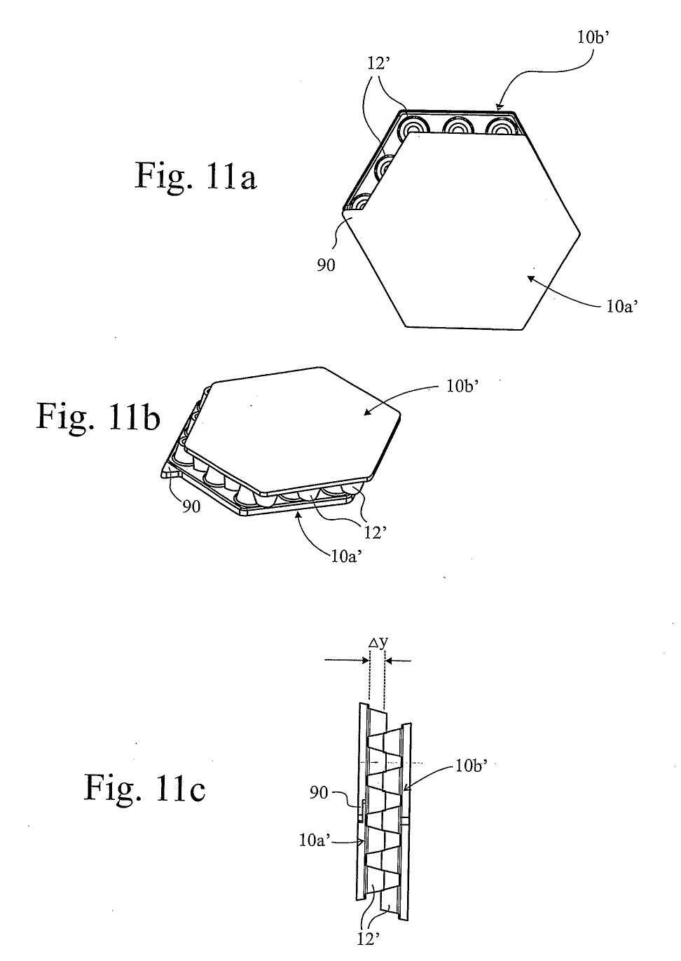

The triangular tab 90 provides a guide for positioning additional pads identical to 10a′, such that the bumps on one pad consistently continue the lattice from the other pads (FIG. 10a). Additionally, the edges of the triangular tab 90 are flush with the edges of additional pads when in a group configuration thus adding to the stability of the configuration. Continuation of the triangular lattice over several pads increases the area able to receive an inverted pad 10b′ and/or allows an inverted pad 10b′ to be received by several pads simultaneously as shown in FIG. 10b. Full engagement of the pads 10a′ and 10b′ is achieved when the bumps of the inverted pad 10b′ slot into the centres of the triangular lattice of the receiving pad(s) 10a′, such that the top sections of the bumps 12′ of the inverted pad 10b′ are flush with the top layer 62 of the receiving pad(s) 10a′ and vice versa. The engagement of two pads is shown more clearly in FIGS. 11a-c. FIGS. 11a and 11b show the two pads 10a′ and 10b′ fully engaged, whereas FIG. 11c shows the pads 10a′ and 10b′ displaced by a distance Δy with respect to one another.

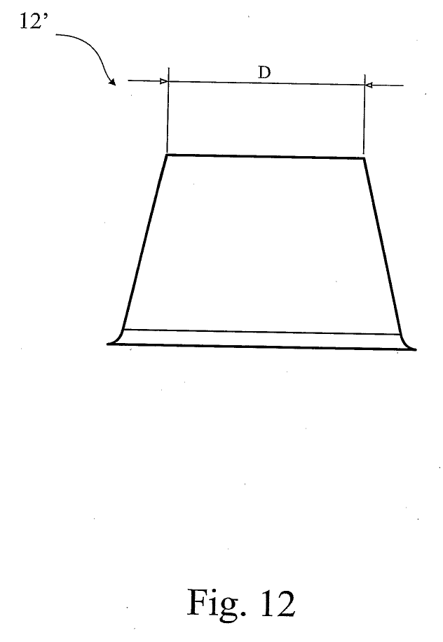

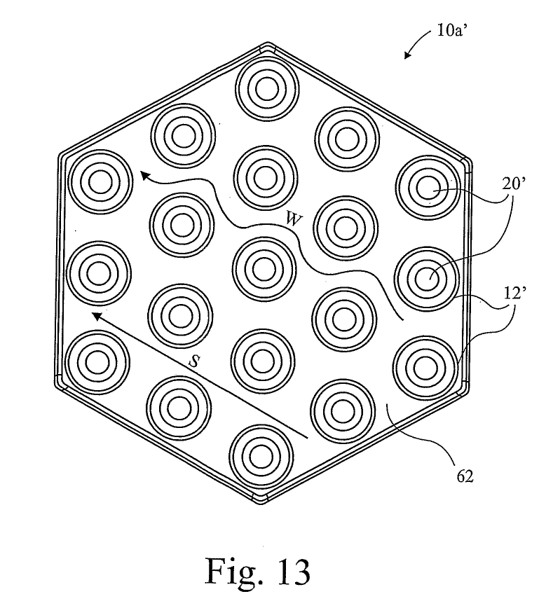

Displacement between the pads 10a′ and 10b′ allows relative lateral movement which is characterised by the magnitude of the displacement Δy. Three dynamic regimes can thus be defined. When Δy=0, the top sections of the bumps of the inverted pad 10b′ are flush with the top layer 62 of the receiving pad(s) 10a′ and there is no relative lateral movement. In this regime the pads 10a′ and 10b′ are “fully engaged”. Lateral movement is only permitted when Ay is large enough to allow the diameter D (see FIG. 12) of the top section of the bumps 12′ to pass through the gaps of adjacent bumps. The minimum value of Δy that permits lateral movement for the bumps 12′ with dimensions given above is Δy=1.00 mm. For this displacement, the bumps 12′ of the inverted pad 10b′ follow curved paths W around the bumps 12′ of the receiving pad 10a′ and are said to “wriggle”. Lateral movement of the pads 10a′,b′ can only occur solely in the “wriggle” regime for the displacements 1.00 mm≦Δy<4.22 mm. For displacements Δy≧4.22 mm, the bumps 12′ of the inverted pad 10b′ are able to move laterally in straight lines S through the bumps 12′ of the receiving pad 10a′. This is the “straight thru” regime when the pads are semi-engaged. In the “straight thru” regime (defined in this case as 4.22 mm≦Δy≦5.00 mm) relative lateral movement of the pads 10a′ and 10b′ is still restricted in that they are not free to move in any direction with respect to one another. Examples of “wriggle” W and “straight thru” S paths as followed by the bumps 12′ of the inverted pad 10b′ are given in FIG. 13.

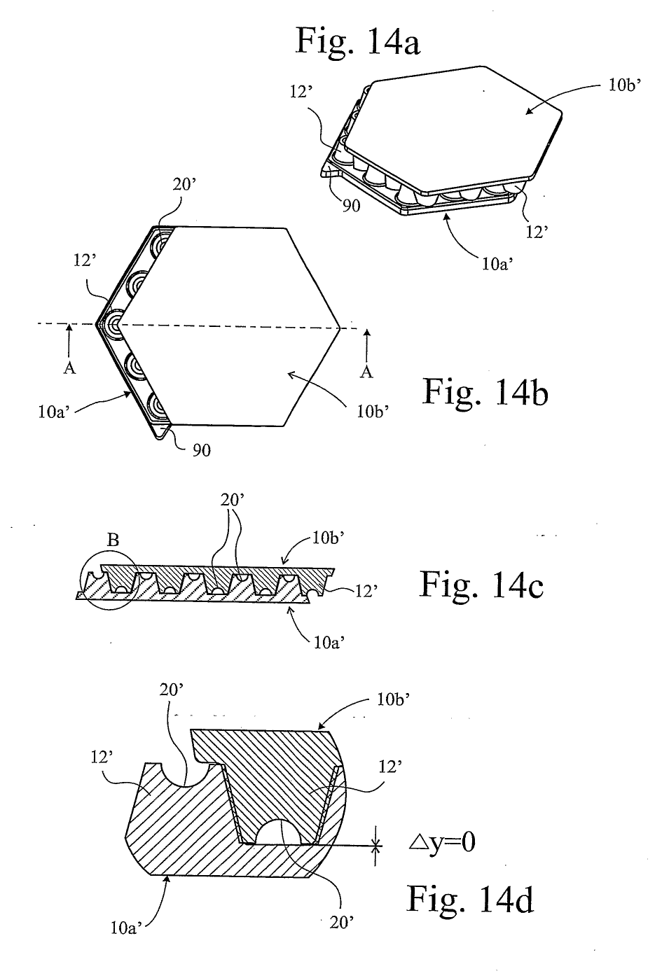

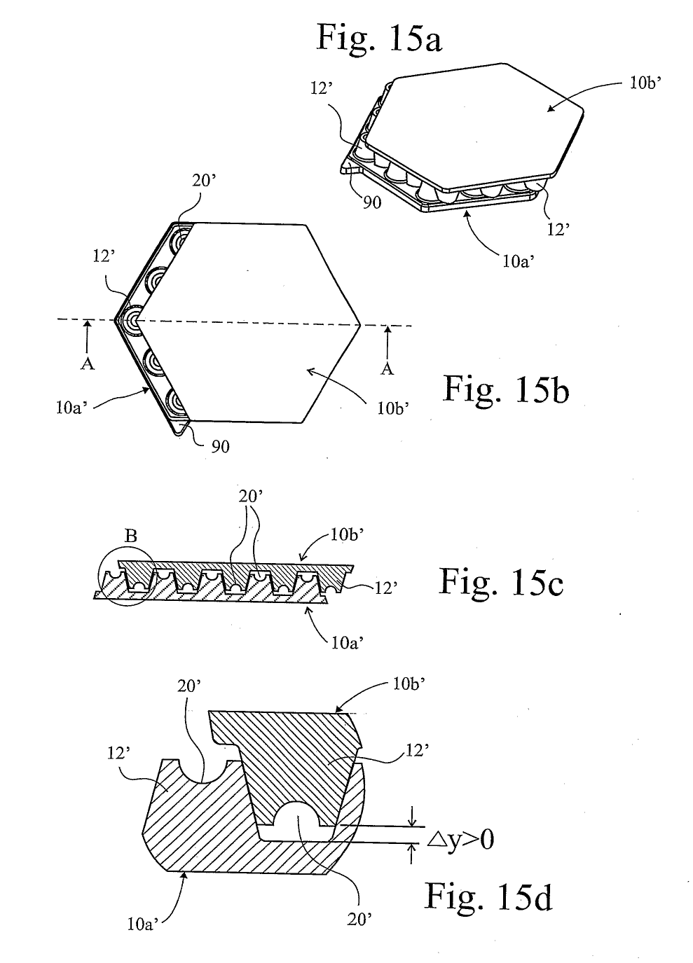

FIGS. 14a-d gives various views of two fully engaged pads 10a′ and 10b′ and FIGS. 15a-d gives various views of two semi-engaged (typical of the “wriggle” and “straight thru” regimes) pads 10a′ and 10b′. From FIG. 14d it can clearly be seen that when the pads 10a′,b′ are fully engaged, their respective bumps 12′ overlap when viewed along the cross section A-A of FIG. 14b. It is thus obvious that the two pads are unable to move laterally when fully engaged. FIG. 15d shows no such overlap however, hence the pads 10a′,b′ are able to move laterally with respect to one another when partially engaged.

The interlocking pads described above and disclosed in FIGS. 9a to 15d, are intended for use on a motorcycle to enhance the grip between the rider and motorcycle 100. The receiving pad 10a′ has the means to be attached to a component of the motorcycle 100 in a location where greater grip is required. The inverted pad 10b′ is then attached to the rider's apparel in a location that will come into contact with the receiving pad when using the motorcycle 100. An example of how the pads 10a′,b′ could be used to improve the rider's grip would be to attach two (or more, as shown for example in FIG. 10a) receiving pads 10a′ to either side of the fuel tank 102 and two inverted pads 10b′ to the inside knee regions of the rider's motorcycle-suit trousers 74. The rider can then press his or her knees towards the bike fuel tank 102 employing the different regimes as required. For example, the rider will require maximum grip to assist in maintaining body position when accelerating or decelerating, so full engagement of the pads 10a′,b′ would be desirable. There may be times however when it will be necessary for the rider to adjust their position on the bike 100 whilst maintaining some grip between the pads 10a′,b′. When the rider is moving from an upright position to a leaning position for cornering for example or vice versa, they will need to quickly adjust the position of their knee with respect to the fuel tank 102. By employing either the “wriggle” or “straight thru” regimes to make the transition, the rider can change their riding position quickly but still maintain some grip. Since the “straight thru” regime allows greater relative movement of the pads 10a′,b′ compared to the “wriggle” regime, less grip is provided. The rider can adjust the level of grip and movement the pads 10a′,b′ will allow by varying the pressure with which he or she presses the pads 10a′,b′ together, thus varying Δy.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A motorcycle grip pad comprising a base layer of elastomeric material having spaced bumps on a top surface thereof and an adhesive layer on a bottom surface thereof, which adhesive layer is provided with a removable release layer protecting said adhesive during handling and which is suitable for adhesion to motor cycle components and in which the area of the pad grip pads are between 1000 and 5000 mm², preferably being between 1200 and 3000 mm² in area, especially between 1300 and 1400 mm².

2. A grip pad as claimed in claim 1, in which the centres of said bumps are spaced from one another by between 8 and 20 mm, and have a base diameter of between 4 and 8 mm.

3. A grip pad as claimed in claim 2, in which said spacing is between 10 and 15 mm.

4. A grip pad as claimed in claim 2, in which said base diameter is between 5 and 7 mm.

5. A grip pad as claimed in claim 1, in which the height of said bumps from said top surface is between 1 and 8 mm.

6. A grip pad as claimed in claim 5, in which said height is between 2 and 5 mm.

7. A grip pad as claimed in claim 1, in which said bumps are truncated cones having a base diameter of between 4 and 8 mm connecting with said top surface, and a top size of between 2 and 5 mm.

8. A grip pad as claimed in claim 7, in which said top size is between 3 and 4 mm.

9. A grip pad as claimed in claim 7, in which the top of said truncated cone is provided with a dimple whereby the top of the bump is a circular ridge.

10. A grip pad as claimed in claim 1, in which said bumps are in an equilateral triangular formation.

11. A grip pad as claimed in claim 10, in which the centres of the bumps are spaced between 10 and 15 mm.

12. A grip pad as claimed in claim 10, in which said grip pad is hexagonal in shape so that multiple pads may be disposed in side by side relation without spaces between.

13. A motorcycle grip system comprising a grip pad as claimed in any preceding claim, and a reaction patch of relatively rigid material having a thickness between 2 and 8 mm and apertures spaced and arranged in the same way as the bumps on the pad, and said patch is adapted for connection to apparel of a motorcycle rider.

14. A grip system as claimed in claim 13, in which said patch is adapted for connection by having a plurality of pin-holes spaced around its circumference whereby it can be sewn to the suit knee without a needle having to puncture the patch in the sewing process.

15. A grip system as claimed in claim 13, in which the patch is a plastics material such as polypropylene or the like.

16. A grip system as claimed in claim 13 in which said apertures are provided on the pad, and said bumps are provided on the patch.

17. A grip system as claimed in claim 16, in which said pad is constructed from said relatively rigid material and the patch is constructed from said elastomeric material.

18. A grip system as claimed in claim 15, in which the reaction patch is adapted for connection by the use hook and pile type fasteners.

19. A motor cycle comprising bodywork including a seat disposed behind a fuel tank, a grip pad as claimed in claim 1 being adhered at least one on each side of the bodywork.

20. A motor cycle as claimed in claim 19, in which the grip pad is adhered to the tank at a location adjacent a respective outside knee of the rider intending to ride the motorcycle when seated on the seat and adopting a cornering attitude with respect to the bike and for each direction of cornering.

21. A wear pad for a motor cycle comprising:
a base sheet in the form of a flexible plastics sheet;
an adhesive layer on the underside side of the flexible sheet;
a release layer under the adhesive layer and protecting it during handling and storage;
a top layer of soft, flexible elastomeric resin, which is poured onto the top surface prior to curing so that it spreads over the pad to its edges; and
bumps of elastomeric material arranged on said base sheet prior to pouring of the polyurethane entrapping said bumps on said sheet, said bumps protruding above the level of said top layer.

22. A wear pad as claimed in claim 21, in which, on a top side of said base sheet decorative or informative indicia is printed, said top layer comprising transparent resin.

23. A wear pad as claimed in claim 21, in which said base sheet is PVC.

24. A wear pad as claimed in claim 21, in which materials of the top layer and bumps are compatible whereby good adhesion between them is achieved.

25. A wear pad as claimed in claim 21, in which said elastomeric resin is a polyurethane.

26. A wear pad as claimed in claim 24, in which said elastomeric resin is a polyurethane and said bumps are made from polyurethane.

27. A wear pad as claimed in claim 21, in which said bumps are interconnected by a network of links.

28. A wear pad as claimed in claim 27, in which said bumps are part of a grip pad according to claim 1, in which said base layer is an open mesh.

29. A wear pad as claimed in claim 28, in which the adhesive layer of the grip pad is omitted, the elastomer poured onto the base sheet adhering and retaining the grip pad to the wear pad base sheet.

30. A wear pad as claimed in claim 29, in which the height of the bumps is measured from the level of top surface of the top layer.

31. Motorcycle riding apparel for a grip system as claimed in claim 15 comprising said reaction patches.

32. Apparel as claimed in claim 31 comprising hoop or hook pile fastener areas adapted for attachment of said reaction patches.

33. Apparel as claimed in claim 32 comprising a pair of trousers, wherein said areas are located on the inside legs of the trousers.

34. Apparel as claimed in claim 32 comprising a jacket, wherein said areas are located on the inside arms of the jacket.

35. Apparel as claimed in claim 32 comprising a pair of boots, wherein said areas are located on the inside ankle or inside calf region of the boots.

36. Apparel as claimed in claim 32 comprising a pair of gloves, wherein said areas are located on the inside wrists of the gloves.

37. A motorcycle grip system comprising two grip pads as claimed in claim 1, or two wear pads as claimed in claim 21, wherein one said pad is attached to the motorcycle body and the other said pad is attached to riding apparel such that the bumps of said pads interlock with one another when said pads are pushed together.

38. A motorcycle grip system as claimed in claim 37, wherein said pads comprise triangular tabs attached to the edges of said tabs to guide and support the arrangement of multiple pads.

39. A motorcycle grip system as claimed in claim 38, wherein the join between said triangular tab and the pad comprises a notch enabling said triangular tab to be easily removed.

40. A motorcycle grip system as claimed in claim 37, wherein multiple pads are arranged in a group with a lattice of bumps consistent across said group.

41. A motorcycle grip system as claimed in claim 40, wherein the bumps of an additional pad can interlock collectively with bumps of said group.

42. A motorcycle grip system as claimed in claim 37, wherein the possible relative lateral movement of said pads is determined by the displacement in a direction perpendicular the plane of said pads.

43. A motorcycle grip system as claimed in claim 42, wherein three dynamic regimes apply to the relative lateral movement of said pads:
i) no relative lateral movement,
ii) relative lateral movement in curved paths as the bumps of one pad move around the bumps of the other pad, and
iii) relative lateral movement in straight lines as the bumps of one pad move between the rows of bumps of the other pad parallel to said rows.

44. (canceled)
